(19) United States
(12) Patent Application Publication
(10) Pub. No.: US 2006/0232926 A1
(43) Pub. Date: Oct. 19, 2006

(54) Security lock

(76) Inventors: Steven S. Homer, Tombal, TX (US); Paul J. Doczy, Cypress, TX (US); Mark C. Solomon, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/107,603

(22) Filed: Apr. 14, 2005

(51) Int. Cl. G06F 1/16

(52) U.S. Cl. 361/686

(57) ABSTRACT

A security lock and method of securing a device are disclosed. In one example embodiment, the lock is integral to a docking station for an electronic device. In some example embodiments, the lock has an interchangeable core.

### FIELD OF THE INVENTION

The present invention relates to security locks, and more specifically to security locks for electronic devices such as notebook computers.

### BACKGROUND OF THE INVENTION

Portable electronic devices, such as laptop or notebook portable computers, are subject to theft when left unattended. Accordingly, locking systems have been developed for securing these devices. For example, one system comprises a key-operated locking mechanism that locks securely to a feature in the portable device, and is also securely connected to a rugged cable that is looped around a fixed object, such as a desk. The connection to the large object makes theft difficult enough that it is substantially discouraged, but the device owner can use the key to free the device for portable use.

### BRIEF DESCRIPTION OF THE DRAWINGS

FIG. 1 depicts a laptop portable computer engaged with a docking station.

FIG. 2 depicts the engagement of the computer and docking station of FIG. 1.

FIG. 3A depicts a security lock in accordance with a first example embodiment of the invention.

FIG. 3B shows a portion of FIG. 3A in a detail view.

FIG. 4A depicts a security lock in accordance with a second example embodiment of the invention.

FIG. 4B shows a portion of FIG. 4A in a detail view.

FIG. 5A depicts a security lock in accordance with a third example embodiment of the invention.

FIG. 5B shows a portion of FIG. 5A in a detail view.

FIG. 6A depicts a security lock in accordance with a fourth example embodiment of the invention.

FIG. 6B shows a portion of FIG. 6A in a detail view.

FIG. 7 shows the security lock of FIGS. 6A and 6B from a reverse angle.

### DETAILED DESCRIPTION

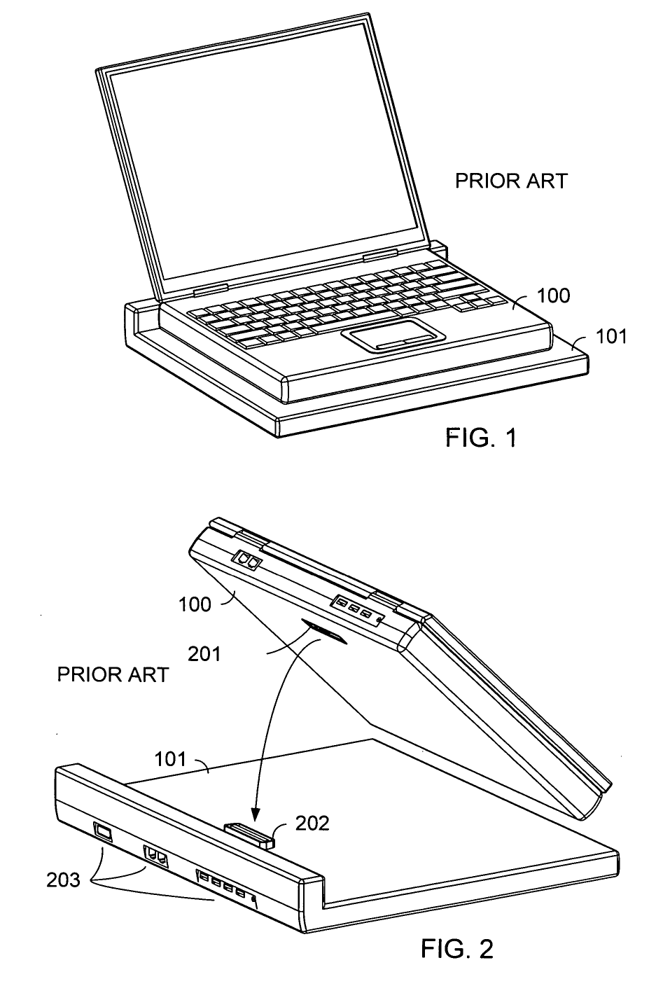

A laptop portable computer serves as an example of a portable electronic device. FIG. 1 depicts laptop portable computer 100 engaged with a docking station 101. A docking station, also called a port replicator, is often used when a portable electronic device is to be used at a fixed location such as an office. Docking station 101 may supply power for recharging batteries in portable computer 100, and may allow connection to computer 100 of more peripheral devices than can be connected directly to computer 100. At least some of the connected peripheral devices may remain at the fixed location and remain connected to docking station 101 when computer 100 is removed from docking station 101 for portable use.

FIG. 2 depicts the engagement of computer 100 with docking station 101. A docking connector 201 on computer 100 engages with a mating connector 202 on docking station 101. Signals pass between computer 100 and peripheral and power connectors 203 through docking connector 201 and mating connector 202.

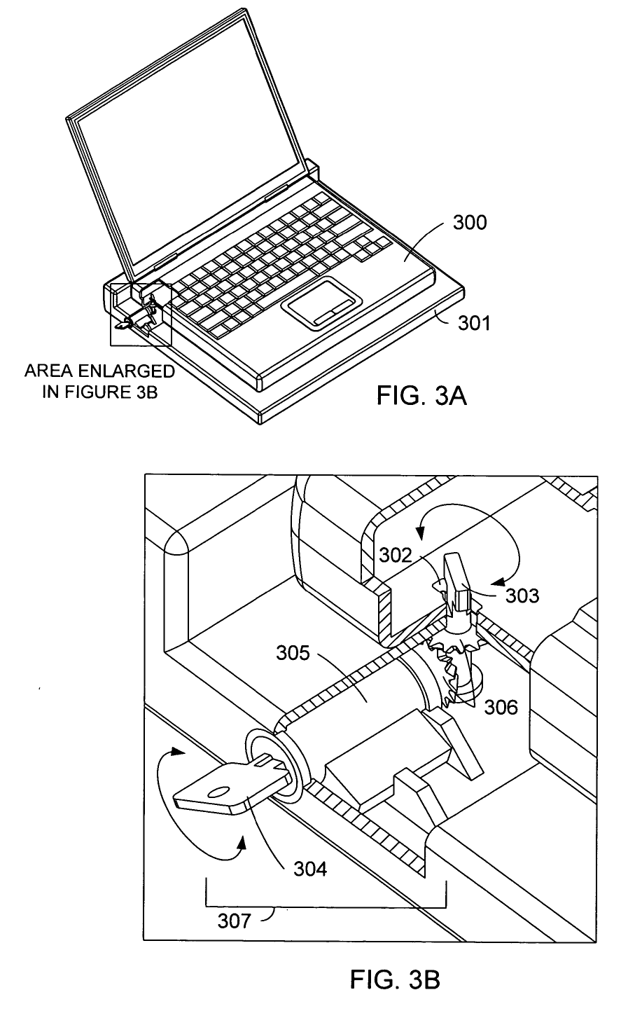

When computer 100 is engaged with docking station 101, it is desirable to provide a locking mechanism to prevent theft of computer 100. FIG. 3A depicts a security lock in accordance with a first example embodiment of the invention. FIG. 3B shows a portion of FIG. 3A in a detail view. Example docking station 301 comprises an integral lock 307, configured to secure laptop portable computer 300 to docking station 301. Both computer 300 and docking station 301 comprise features for implementing the embodiment, and are shown in cutaway view. Many internal components of computer 300 and docking station 301 have been omitted for clarity in illustrating the security lock. Computer 300 comprises an oblong slot 302. Docking station 301 comprises T-shaped locking feature 303, which engages a receiving feature, slot 302, as computer 300 is docked to docking station 301. Once computer 300 is docked, the user actuates the lock by turning key 304, which in turn causes lock feature 303 to turn crossways to slot 302, securing computer 300 to docking station 301. Docking station 301 may be further secured, for example to a large object using a conventional cable lock, or by other means. Once key 304 is removed, computer 300 is secure. In this first example embodiment, computer 300 may be locked to docking station 301 without the difficulty of maneuvering a flexible cable.

While the example embodiment of FIGS. 3A and 3B comprises a conventional lock cylinder 305, and accomplishes its locking function by turning lock feature 303 through a set of angle gears 306, one of skill in the art will recognize that other mechanisms may be used to accomplish the locking function. Furthermore, the security lock may be used with other kinds of portable electronic devices, for example a personal digital assistant (PDA). A PDA is a small, usually handheld, device that stores and displays information for ready access. Typically, a PDA is used to store address and telephone number data, email, documents, digitized music or photographs, or other kinds of data. A docking station for a PDA may enable the PDA to synchronize its data with a host computer, recharge its batteries, or provide other functions.

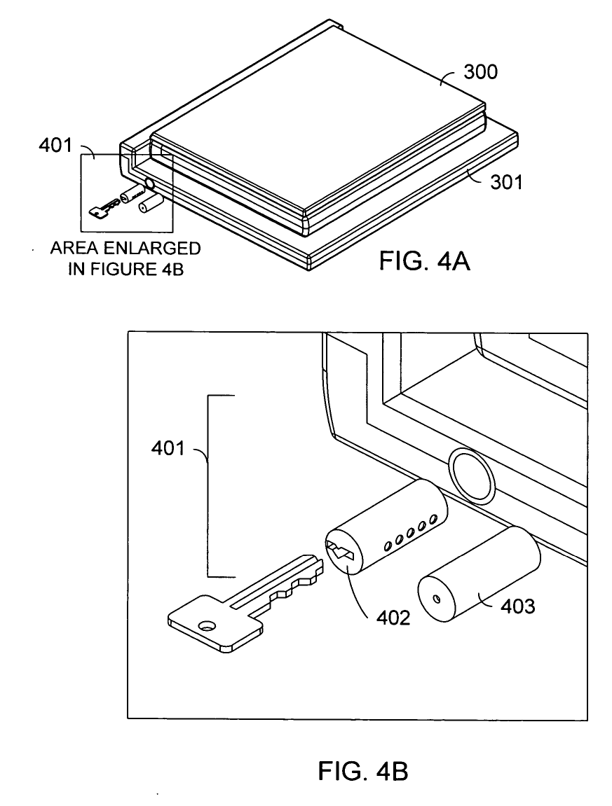

FIG. 4A depicts a security lock in accordance with a second example embodiment of the invention. FIG. 4B shows a portion of FIG. 4A in a detail view. In this second example embodiment, lock 401, shown in an exploded view, comprises an interchangeable core 402. Interchangeable core locks are known for other uses. See for example U.S. Pat. No. 4,123,926 to Elder. An interchangeable core lock enables a user or lock systems manager to re-key the lock by simply replacing core 402. The core is removed using a special key called a control key. A control key not only opens the lock as a normal key does, but also disengages the core from the lock housing. In order to re-key the lock, once the core has been removed a new core is inserted that configures the lock to be openable by a different key. Some standard core configurations are available. For example, cores complying with the Small Format Interchangeable Core (SFIC) standard are available from several manufacturers, so that locks from several different manufacturers may be configured to be openable by the same key.

A security lock in accordance with the example embodiment of FIGS. 4A and 4B provides several advantages. A user of a portable electronic device such as computer 300 may wish to minimize the number of keys to maintain and carry. The security lock of FIGS. 4A and 4B could be keyed, for example, to use the same key as the user's office door, filing cabinets, or other secured areas. An institutional purchaser of electronic equipment may wish to integrate its security for the electronic equipment into existing procedures. For example, a large organization may have a preferred supplier of locks and keys, and institutionalized procedures for managing keys. Such an organization could purchase docking stations with blank cores of minimal cost, such as blank core 403, placed in the lock mechanisms. The organization could then remove the blank cores and install its own preferred cores. This relieves the supplier of the docking stations from the need to track individual locks and keys, and may result in a reduced cost for the docking stations. Blank core 403 may be, for example, a simple injection-molded plastic part, or a part made by another process of similarly low cost.

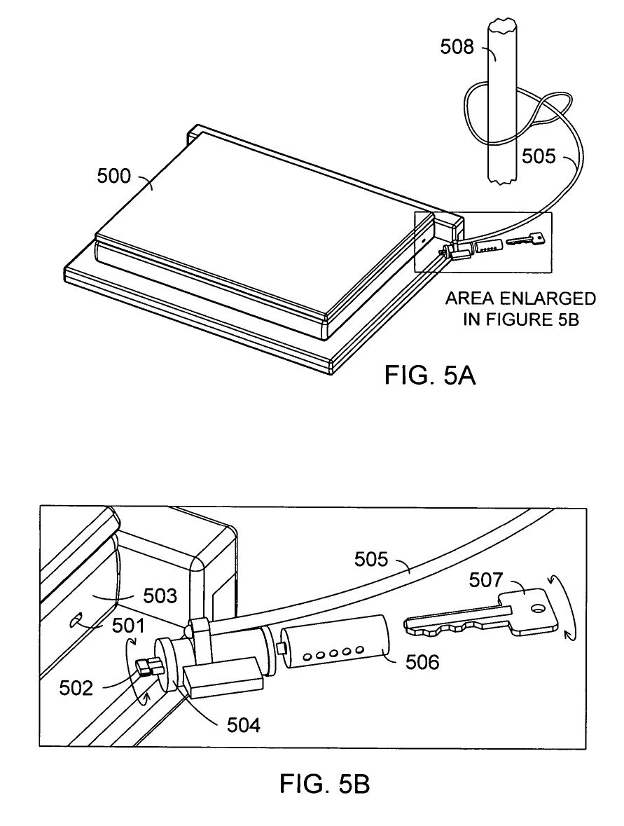

FIG. 5A depicts a security lock in accordance with a third example embodiment of the invention. FIG. 5B shows a portion of FIG. 5A in a detail view. This third example embodiment provides the advantages of an interchangeable core lock in a cable lock. Laptop portable computer 500 comprises an oblong slot 501. In the locked position, T-shaped locking feature 502 protrudes through slot 501 and is turned, using key 507, so that the lobes of feature 502 are captured against the inside of wall 503 of computer 500, and lock housing 504 is captured against computer 500. Housing 504 is securely attached to cable 505, which may be looped around an object such as pillar 508. Housing 504 is configured to accept interchangeable core 506. The security lock of FIGS. 5A and 5B can thus be re-keyed easily using a control key.

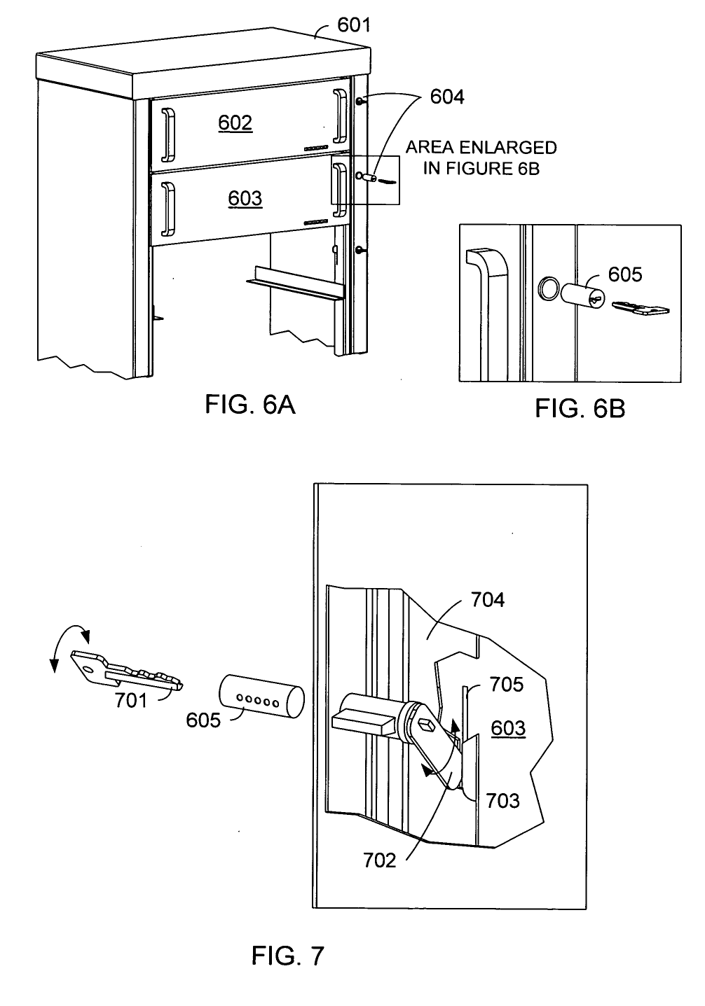

A security lock embodying the invention is not limited in application to securing portable electronic devices. FIG. 6A depicts a security lock in accordance with a fourth example embodiment of the invention. FIG. 6B shows a portion of FIG. 6A in a detail view. Equipment rack 601 holds one or more rack-mounted electronic devices 602, 603. The electronic devices may be server computers, electronic test equipment, other kinds of electronic devices, or any combination of these. Each bay of equipment rack 601 is equipped with a security lock exemplified by lock 604. Security lock 604 has an interchangeable core 605.

FIG. 7 shows security lock 604 from a reverse angle. When lock 604 is fully assembled and key 701 is inserted and turned, locking bar 703 turns, engaging or disengaging slot 703 in cabinet member 704. When electronic device 603 is inserted into rack 601, slot 705 in device 603 aligns with slot 703. Locking bar 703 engages both slots when lock 604 is in the locked position, making it very difficult to remove device 603 from rack 601 without key 705. Using an interchangeable-core lock to secure an electronic device in a rack provides the advantages described above. Lock 604 may be easily re-keyed, and may be configured to use the same key as other locks accessed by the user of the rack system.

1. A docking station for an electronic device, comprising:
a lock integral to the docking station; and
a locking feature configured to secure the electronic device to the docking station in response to the lock, the lock and locking feature substantially preventing separation of the docking station and the electronic device except by use of a key.

2. The docking station of claim 1, wherein the electronic device is a portable computer.

3. The docking station of claim 1, wherein the electronic device is a personal digital assistant.

4. The docking station of claim 1, wherein the lock further comprises an interchangeable core.

5. The docking station of claim 4, wherein the core can be removed using a control key.

6. The docking station of claim 4, wherein the lock conforms to the Small Format Interchangeable Core standard.

7. The docking station of claim 1, wherein the locking feature is T-shaped and the receiving feature is a slot.

8. A method of securing an electronic device to a docking station, comprising:
docking the electronic device with the docking station;
engaging a locking feature comprised in the docking station with a receiving feature comprised in the electronic device; and
actuating a lock integral to the docking station using a key, causing the locking feature and receiving feature to substantially prevent separation of the electronic device and the docking station except by use of a key.

9. The method of claim 8, wherein the electronic device is a portable computer.

10. The method of claim 8, wherein the electronic device is a personal digital assistant.

11. The method of claim 8, wherein the lock comprises an interchangeable core, the core replaceable using a control key.

12. A lock, comprising:
a housing;
a cable securely attached to the housing;
a locking feature, actuated by the lock and configured to engage an item to be secured by the lock; and
an interchangeable core, removable using a control key.

13. The lock of claim 12, wherein the item to be secured is an electronic device.

14. The lock of claim 13, wherein the item to be secured is a portable computer.

15. The lock of claim 13, wherein the item to be secured is a personal digital assistant.

16. The lock of claim 12, wherein the cable is configured to loop around a fixed object.

17. The lock of claim 12, wherein the interchangeable core conforms to the Small Format Interchangeable Core standard.

18. A method of securing an item, comprising:
looping a cable around a substantially fixed object;
fixing the cable to a housing of a lock, the lock comprising an interchangeable core, replaceable using a control key; and
engaging a locking feature, actuated by the lock, with the item to be secured.

19. The method of claim 18, wherein the item to be secured is an electronic device.

20. The method of claim 19, wherein the item to be secured is a portable computer.

21. The method of claim 19, wherein the item to be secured is a personal digital assistant.

22. A system, comprising:
an equipment rack having at least one bay, each bay configured to accept a rack-mounted electronic device;
a lock associated with a bay, the lock further comprising an interchangeable core; and
a locking feature actuated by the lock such that when the lock is in its locked position, the locking feature engages an electronic device in the associated bay and substantially prevents the removal of the electronic device from the rack, except by use of a key.

23. The system of claim 22, wherein the core conforms to the Small Format Interchangeable Core standard.

24. The system of claim 22, wherein the core can be removed from the lock using a control key.

25. A method of securing an electronic device, comprising:
providing an equipment rack having at least one bay configured to accept the electronic device;
providing a lock associated with a bay, the lock comprising an interchangeable core;
providing a locking feature actuated by the lock such that when the lock is locked, the locking feature engages the electronic device and renders removal of the electronic device from the rack very difficult, except by use of a key.

26. The method of claim 25, wherein providing a lock comprising an interchangeable core further comprises providing a lock with a core that can be removed using a control key.

27. The method of claim 25, wherein providing a lock comprising an interchangeable core further comprises providing a lock with a core in the Small Format Interchangeable Core size.

28. A method of securing an electronic device, comprising:
obtaining a docking station for the electronic device, the docking station comprising an integral lock configured to accept an interchangeable core;
inserting an interchangeable core into the lock;
docking the electronic device to the docking station, engaging a locking feature comprised in the docking station with a receiving feature comprised in the electronic device; and
locking the lock, thereby actuating the locking feature so that the electronic device is secured to the docking station.

29. The method of claim 28, further comprising removing a key from the lock.
